(19) United States
(12) Patent Application Publication
(10) Pub. No.: US 2011/0097029 A1
(43) Pub. Date: Apr. 28, 2011

(54) Super Flat Optical Frequency Comb Signal Generator

(75) Inventors: Takahide Sakamoto, Tokyo (JP); Tetsuya Kawanishi, Tokyo (JP); Masahiro Tsuchiya, Tokyo (JP); Masayuki Izutsu, Tokyo (JP)

(73) Assignee: NATIONAL INSTITUTE OF INFORMATION AND COMMUNICATIONS TECHNOLOGY, Koganei-shi, Tokyo (JP)

(21) Appl. No.: 12/864,507

(22) PCT Filed: Jan. 27, 2009
(86) PCT No.: PCT/JP2009/000301

§ 371 Date: Dec. 1, 2010

(30) Foreign Application Priority Data
Jan. 28, 2008 (JP) 2008-015911

(51) Int. Cl. G02F 1/01; G02F 1/225

(52) U.S. Cl. 385/3

(57) ABSTRACT

It is an object of the present invention to provide an optical frequency comb generator to generate an optical frequency comb with flat spectral properties using a single modulator. The optical frequency comb generator comprises: a drive signal system (11) and a bias signal system (14) for driving a first drive signal (9), a second drive signals (10), and bias signals (12,13) in accordance with the following Formula (I):

ΔA±Δθ=π/2 (I)

(where ΔA and Δθ are defined, respectively, as ΔA=(A₁−A₂)/2 and Δθ=(θ₁−θ₂)/2, A₁ and A₂ indicate, respectively, optical phase shift amplitudes guided by the first drive signal and the second drive signal when input into the electrodes, and θ₁ and θ₂ indicate, respectively, the phases of the bias signals applied to the first waveguide and the second waveguide).

### FIELD OF INVENTION

The present invention relates to an ultra-flat optical frequency comb signal generator that generates an optical frequency comb signal with high flatness using a Mach-Zehnder optical modulator. More specifically, the present invention relates to an optical frequency comb generator that can generate an optical frequency comb simply and stably even if a single modulated signal is used.

### DESCRIPTION OF THE RELATED ART

Recently, there have been high expectations for optical frequency comb generation technique that has the function of simultaneously generating a plurality of optical frequency components having the same frequency intervals. Such an optical frequency comb generator that can generate an optical frequency comb can be applied as a wavelength multiplexing light source in optical wavelength division multiplexing system or a short-pulse light source for ultrahigh-speed optical transmission/optical measurement. Furthermore, the application of an optical frequency comb generator to an optical frequency reference for absolute frequency measurement, remote supply of local signals in microwave/millimeter-wave frequency bands has also been considered (W. D. Jemison et al., MWP' 01, pp. 169-172, 2001). Also, the use of an optical frequency comb generator as a control signal for an allay antenna used in an astronomical observation system such as a wireless telescope has also been considered (J. M. Payne and W. P. Shillue, MWP' 02, pp. 9-12, 2002).

As a method for generating an optical frequency comb, the use of optical modulation technique such as LiNbO₃ in addition to the use of a mode-locked laser using semiconductors or optical fibers has been considered (For example, see Non-Patent Documents 1-3 as indicated below).

An optical frequency comb ideally has flat spectral properties. Namely, respective frequency components ideally have the same optical intensity. Even if an optical frequency comb is generated using a LiNbO₃ modulator, it is a critical issue to obtain an optical frequency comb having flat spectral properties. If a LiNbO₃ modulator is driven using drive signals having large amplitude, phase modulated light can be obtained by an electro-optic effect. Though, as a result, an optical frequency comb can be obtained, the optical intensity of high-order modulation components of the generated optical signal follows Bessel function corresponding to respective degrees. Bessel function is a quasi-periodic function with different phases depending on orders. Therefore, there is a problem that the optical intensity of respective frequency components of phase modulated light largely depends on the amplitude of drive signals and thus it is hard to obtain flat spectral properties.

On the other hand, a method to generate an optical frequency comb signal having flat spectral properties by a combination of an optical phase modulator and an optical intensity modulator has been suggested. The method drives both an optical phase modulator and an optical intensity modulator by synchronizing signals of the same frequency and drives a first-stage optical phase modulator by large amplitude signals and generate high-order modulated components, and subsequently intensity modulation is carried out by a directly-connected latter-stage modulator. The sideband components formed from respective frequency components of phase modulated light interfere with neighboring-order frequency components, which lessens the deviation of an optical spectrum. Furthermore, by controlling optical intensity on the time axis, only the nonlinear chirp of phase modulated light is selectively formed.

However, though an optical frequency comb with high spectral flatness can be obtained by the above conventional methods, they require the synchronizing drive with two directly-connected optical modulators. Thus, there is a problem of more complicated configuration of an optical frequency comb generator.

Consequently, the present inventors have developed an optical frequency comb generator having the same optical frequency intervals and flat optical spectral properties, by driving both arms of a single Mach-Zehnder optical modulator by large amplitude sinusoidal signals of different amplitudes and by setting the intensity of a resulting vector of respective frequency components of the comb generated by the adjustment of drive voltage.

As the optical frequency comb generator can generate an optical frequency comb signal only using a single Mach-Zehnder optical modulator, it is an easy-to-use and very excellent device. However, the optical frequency comb generator also has a problem that it requires two types of modulated signals so as to drive both arms of a single Mach-Zehnder optical modulator by large amplitude sinusoidal signals of different amplitudes.
Non-Patent Document 1: M. Sugiyama et al., OFC' 02, FB6, 2002
Non-Patent Document 2: T. Sakamoto et al., MWP' 04, MC16, 2004
Non-Patent Document 3: T. Kawanishi et al., IEICE Electron Express, Vol. 1, pp. 217-221, 2004

### DISCLOSURE OF THE INVENTION

### Problems to be Solved by the Invention

It is an object of the present invention to generate an optical frequency comb signal having the same optical frequency intervals and flat optical spectral properties, with one type of modulated signals, using a single optical modulator (preferably, only a single Mach-Zehnder optical modulator without using a phase modulator etc.), and to provide an optical frequency comb generator that can obtain such an optical frequency comb signal.

It is another object of the present invention to provide an optical pulse generator using the above optical frequency comb generator.

### Means for Solving the Problems

The present invention is basically based on a knowledge that an optical frequency comb having flat spectral properties can be obtained even with the use of a single modulated signal, by making the length of a first modulated electrode (15) provided along a first waveguide (4) of a Mach-Zehnder optical modulator and that of a second modulated electrode (16) provided along a second waveguide (5) different from each other, or by displacing the position of either or of both of the first waveguide (4) and the second waveguide (5) so that they are positioned asymmetrically with respect to the position where modulation efficiency is maximum. As an optical phase modulator is originally to modulate the phase of an input signal, it is respected that only the signals with the phases of the input optical signals modulated by a predetermined amount are output. However, an optical phase modulator generates a plurality of frequencies of optical spectra as noise other than signals modulated by a predetermined amount. And the intensity of the plurality of frequency components follows Bessel function. Therefore, by multiplexing the optical signals output from two optical phase modulators, effectively using respective frequency components output as noise and appropriately compensating the optical intensity of respective frequency components, an optical frequency comb having a flat spectral property can be obtained even with the use of a single optical modulator.

In order to obtain an optical frequency comb, an optical signal may be adjusted so that the output from both arms of a Mach-Zehnder modulator may be an optical frequency comb signal if multiplexed. The present invention, from such a standpoint, applies bias signals or modulated signals, and also adjusts the length of modulated electrodes provided on respective arms or places waveguides asymmetrically.

Specifically, an optical frequency comb generator of the present invention comprises: a waveguide part (8) comprising an optical input part (2), a branching part (3) for branching light from the optical input part, a first waveguide (4) through which light branched by the branching part (3) propagates, a second waveguide (5) through which other light branched by the branching part (3) propagates, a multiplexing part (6) for multiplexing optical signals output from the first waveguide and the second waveguide, and an optical signal output part (7) for outputting optical signals multiplexed by the multiplexing part; a drive signal system (11) for obtaining a first drive signal (9) for driving the first waveguide and a second drive signal (10) for driving the second waveguide; and a bias signal system (14) for obtaining bias signals (12,13) applied to the first waveguide and the second waveguide, wherein the first drive signal (9) and the second drive signal (10) are obtained from one drive signal system (11), wherein the length l₁ of a first modulated electrode (15) provided along the first waveguide (4) and the length l₂ of a second modulated electrode (16) provided along the second waveguide (5) are different from each other, and wherein the drive signal system (11) and the bias signal system (14) drive the first drive signal (9), the second drive signal (10) and the bias signals (12,13) in accordance with the following Formula (I):

ΔA±Δθ=π/2 (I)

(where ΔA and Δθ are defined, respectively, as ΔA≡(A₁−A₂)/2 and Δθ≡(θ₁−θ₂)/2, and A₁ and A₂ indicate, respectively, optical phase shift amplitudes induced by the first drive signal and the second drive signal when input into the electrodes, and θ₁ and θ₂ indicate, respectively, optical phase shift amounts induced within the first waveguide and the second waveguide.) As used herein, the optical phase shift amplitude (A₁) induced by the first drive signal is also simply referred to as amplitude of the first drive signal, and the optical phase shift amplitude (A₂) induced by the second drive signal is also simply referred to as amplitude of the second drive signal. Furthermore, the term “amplitude of a drive signal” as used herein refers to optical phase shill amplitude induced by a drive signal according to the context.

As described later, by driving in order to the above Formula (I), an optical frequency comb having flat spectral properties with mutually complemented optical signals from two multiplexed phase modulators (the phase modulators are made up of waveguides and electrodes where drive signals are applied) can be obtained.

A preferred embodiment of the optical frequency comb generator according to the first aspect of the present invention is an optical frequency comb generator as described above, wherein the drive signal system (11) and the bias signal system (14) drive the first drive signal (9), the second drive signal (10), and the bias signals (12,13) in accordance with the following Formula (II) instead of the above Formula (I):

ΔA=Δθ=π/4 (II)

(where ΔA and Δθ are defined synonymously above)

As Formula (II) meets Formula (I), by driving the signals in accordance with Formula (II), an optical frequency comb having flat spectral properties can be obtained. Furthermore, as described later, by driving in accordance with Formula (II), an optical frequency comb having flat spectral properties can effectively be obtained.

A preferred embodiment of the optical frequency comb generator according to the first aspect of the present invention is an optical frequency comb generator as described in any of above, wherein the amplitude (A₁) of the first drive signal and the amplitude (A₂) of the second drive signal are different.

In general, a dual-drive optical modulator uses two drive signals with the same amplitude. However, in the present invention, drive signals are configured to obtain an optical frequency comb having flat spectral properties. Thus, as two drive signals are controlled to meet the predefined condition, the amplitude of the two drive signals are different.

A preferred embodiment of an optical frequency comb generator according to the first aspect of the present invention is an optical frequency comb generator as described in any of above, wherein the waveguide part (8) is a Mach-Zehnder waveguide.

A Mach-Zehnder waveguide, and an optical modulator (Mach-Zehnder modulator) comprising a Mach-Zehnder waveguide and a drive signal system, are known. Therefore, an optical frequency comb generator can easily be produced using a known Mach-Zehnder waveguide and a drive signal system. Each of the two post-branch waveguides consisting of a Mach-Zehnder waveguide is also referred to as “arm”. A Mach-Zehnder waveguide comprises approximately hexagonally-shaped waveguides (they make up two arms), for example, and is made up with two parallel phase modulators. A phase modulators can be attained by an electrode along a waveguide.

The amounts of optical phase shift induced by both arms in a Mach-Zehnder waveguide are different, and thus frequency period against the applied voltage of frequency components induced in each arm is also different. By controlling drive voltage so that the frequency phase difference against the drive voltage may become 90 degrees between both arms and thus configuring the resulting vector intensity of the generated respective frequency components to a constant value, frequency dependency of optical intensity at the multiplexed optical spectrum can be lessened. As a result, a flat optical frequency comb can be obtained.

A preferred embodiment of an optical frequency comb generator according to the first aspect of the present invention relates to the optical frequency comb generator as described in any of above, wherein the first modulated electrode (15) and the second modulated electrode (16) are electrically connected, wherein the drive signal system (11) drives modulated signals so that drive signals are input into the second modulated electrode (16) and the modulated signals output from the second modulated electrode (16) are input into the first modulated electrode (15) and the modulated signals applied to the second modulated electrode (16) and the modulated signals applied to the first modulated electrode are of the same phase. Even in this case, modulation efficiency can be adjusted by adjusting the length of the first modulated electrode (15) and that of the second modulate electrode (16). Also, modulation efficiency can be adjusted by adjusting the cross-section structure of the electrodes. In this way, drive signals from the drive signal system (11) are input into the second modulated electrode (16) and the modulated signals output from the second modulated electrode (16) are input into the first modulate electrode (15), thereby improving power efficiency by around 3 dB.

A preferred embodiment of the optical frequency comb generator according to the present invention relates to the optical frequency comb generator as described in any of above, wherein the waveguide part (8) is provided on a domain inverted ferroelectric crystal substrate. As the use of a domain inverted (crystal-axis inverted structure) ferroelectric crystal (LN crystal) can apply in-phase and the same coded modulation to each waveguide, phase shift can be added to the ends of electrodes from one electrode, thereby generating a comb at one electrode only.

A preferred usage mode of the optical frequency comb generator according to the first aspect of the present invention relates to an optical pulse generator comprising: an optical frequency comb generator as described in any of above, a bandpass filter (22) into which output from the optical frequency comb generator is input, and a distributed fiber (23) into which output from the bandpass filter is input. Namely, an ultrashort pulse laser such as a picosecond pulse laser or a femtosecond pulse laser can easily be obtained only by connecting a bandpass filter and an optical fiber to the above optical frequency comb generator.

The optical frequency comb generator according to the second aspect of the present invention relates to an optical frequency comb generator comprising: a waveguide part (8) comprising an optical input part (2), a branching part (3) for branching light from the optical input part, a first waveguide (4) through which light branched by the branching part (3) propagates, a second waveguide (5) through which other light branched by the branching part (3) propagates, a multiplexing part (6) for multiplexing optical signals output from the first waveguide and the second waveguide, and an optical signal output part (7) for outputting optical signals multiplexed by the multiplexing part; a drive signal system (11) for obtaining a first drive signal (9) for driving the first waveguide and a second drive signal (10) for driving the second waveguide; and a bias signal system (14) for obtaining bias signals (12,13) applied to the first waveguide and the second waveguide, wherein the first drive signal (9) and the second drive signal (10) are obtained from one drive signal system (11), wherein either or both of the first waveguide and second waveguide are displaced from the condition where modulation efficiency becomes maximum in accordance with the above Formula (I), and wherein the drive signal system (11) and the bias signal system (14) drive the first drive signal (9), the second drive signal (10) and the bias signals (12,13) in accordance with the above Formula (I).

### EFFECT OF THE INVENTION

According to the present invention, an optical frequency comb can be generated having flat spectral properties with a single optical modulator by driving the optical modulator according to prescribed conditions. Thus, compared to an optical frequency comb generator using a Mach-Zehnder optical modulator applying two types of drive signals (modulated signals), the optical frequency comb generator according to the present invention has a simple structure and a simple drive system, and is also easy to operate as it is not necessary to be driven by two modulated signals.

As the present invention can provide an optical pulse generator using the optical frequency comb generator as described above, an optical pulse generator having the effect as described above can be provided.

### THE BEST MODE FOR CARRYING OUT THE INVENTION

### Optical Frequency Comb Generator

Hereinafter, an optical frequency comb generator of the present invention will be described with reference to the accompanying drawings. FIG. 1 is a schematic diagram of an optical frequency comb generator of the present invention. As shown in FIG. 1, an optical frequency comb generator (1) of the present invention comprises: an optical input part (2), a branching part (3) for branching light from the optical input part, a first waveguide (4) through which light branched by the branching part (3) propagates, a second waveguide (5) through which other light branched by the branching part (3) propagates, a multiplexing part (6) for multiplexing optical signals output from the first waveguide and the second waveguide, and an optical signal output part (7) for outputting optical signals multiplexed by the multiplexing part; a drive signal system (11) for obtaining a first drive signal (9) for driving the first waveguide and a second drive signal (10) for driving the second waveguide; and a bias signal system (14) for obtaining bias signals (12,13) applied to the first waveguide and the second waveguide.

The first drive signal (9) and the second drive signal (10) are obtained from one drive signal system (11). The length l₁ of a first modulated electrode (15) provided along the first waveguide (4) and the length l₂ of a second modulating electrode (16) provided along the second waveguide (5) are different. The drive signal system (11) and the bias signal system (14) drive the first drive signal (9), the second drive signal (10) and the bias signals (12,13) in accordance with the following Formula (I):

ΔA±Δθ=π/2 (I)

(where ΔA and Δθ are defined, respectively, as ΔA≡(A₁−A₂)/2 and Δθ≡(θ₁−θ₂)/2, A₁ and A₂ indicate, respectively, optical phase shift amplitudes induced by the first drive signal and the second drive signal when input into the electrodes, and θ₁ and θ₂ indicate, respectively, optical phase shift amounts induced by optical length differences, bias signals, etc. within the first waveguide and the second waveguide.) Namely, the optical frequency comb generator of this embodiment comprises the drive signal system (11) and the bias signal system (14) for driving the first drive signal (9), the second drive signal (10), and the bias signals (12,13) as shown in the above Formula (I).

As described later, by driving in order to the above Formula (I), an optical frequency comb having flat spectral properties with mutually complemented optical signals from two multiplexed phase modulators (the phase modulators are made up of waveguides and electrodes where drive signals are applied) can be obtained.

In case the drive signals meet Formula (I), l₁ and l₂ may ideally be configured to meet the below-mentioned formula.

A preferred embodiment of the optical frequency comb generator according to the first aspect of the present invention is an optical frequency comb generator as described above, wherein the optical frequency comb generator drives in accordance with the following Formula (II):

ΔA=Δθ=π/4 (II)

(where ΔA and Δθ are defined synonymously above.) Namely, the optical frequency comb generator of this embodiment comprises the drive signal system (11) and the bias signal system (14) for driving the first drive signal (9), the second drive signal (10), and the bias signals (12,13) as shown in the above Formula (II).

As Formula (II) meets Formula (I), by driving in accordance with Formula (II), an optical frequency comb having flat spectral properties can be obtained. Furthermore, as described later, by driving in accordance with Formula (II), an optical frequency comb having flat spectral properties can effectively be obtained.

A preferred embodiment of an optical frequency comb generator according to the first aspect of the present invention is the optical frequency comb generator as described in any of above, wherein the amplitude (A₁) of the first drive signal and the amplitude (A₂) of the second drive signal are different.

As a flat optical frequency comb spectrum can be obtained on the condition of Formula (I) as described later in case the amplitude of drive signals is large, the amplitude of the drive signals may be more than π, preferably more than 2π or 3π. On the other hand, in the present invention, the amplitude of two drive signals is preferably different, and thus the value of the amplitude difference may be 0−π, more preferably 0−0.5π or 0−0.25π.

In general, two drive signals in a dual-drive optical modulator have the same amplitude. However, in the present invention, drive signals are configured to obtain an optical frequency comb having flat spectral properties. In this way, two drive signals are controlled to meet the predefined condition, and thus the amplitude of two drive signals is different.

A preferred embodiment of the optical frequency comb generator according to the first aspect of the present invention is the optical frequency comb generator as described in any of above, wherein the waveguide (8) is a Mach-Zehnder waveguide.

A Mach-Zehnder waveguide, and an optical modulator (Mach-Zehnder modulator) comprising a Mach-Zehnder waveguide and a drive signal system, are known. Therefore, an optical frequency comb generator can easily be produced using a known Mach-Zehnder waveguide and a drive signal system. Each of the two post-branch waveguides consisting of a Mach-Zehnder waveguide is also referred to as “arm”. A Mach-Zehnder waveguide comprises approximately hexagonally-shaped waveguides (they make up two arms), for example, and is made up with two parallel phase modulators. A phase modulators can be attained by an electrode along a waveguide.

The amounts of optical phase shift induced by both arms in a Mach-Zehnder waveguide are different, and thus frequency period against the applied voltage of frequency components induced in each arm is also different. By controlling drive voltage so that the frequency phase difference against the drive voltage may become 90 degrees between both arms and thus configuring the resulting vector intensity of the generated respective frequency components to a constant value, frequency dependency of optical intensity at the multiplexed optical spectrum can be lessened. As a result, a flat optical frequency comb can be obtained. As an optical comb can generate an optical pulse signal corresponding to the bandwidth, an optical frequency comb generator can also be referred to as an ultrahigh precision multifrequency optical pulse generator. Namely, the present invention also provides a multifrequency optical pulse generator appropriately comprising a configuration of the above optical frequency comb generator.

FIG. 2 is a schematic diagram showing a preferred configuration of an optical frequency comb generator of another embodiment of the present invention. In FIG. 1, drive signals are branched from the drive signal system, and the branched drive signals are applied to each of the first modulated electrode (15) and the second modulated electrode (16). However, in the subject embodiment, output from the drive signals applied to any of the modulating electrodes is applied to other electrode(s). At that time, the phase may be adjusted so that the applied modulated signals may be opposite phase (or coordinate phase). Specifically, the drive signals from the drive signal system (11) may be input into the second modulated electrode (16) and the modulated signals output from the second modulated electrode (16) may be input into the first modulated electrode (15) while driving the signals in accordance with Formula (I) or Formula (II). The modulated signals applied to the second modulated electrode (16) and the modulated signals applied to the first modulated electrode (15) are preferably applied so as to be in-phase. Even in this case, modulation efficiency can be adjusted by adjusting the length of the first modulated electrode (15) and that of the second modulated electrode (16). Modulation efficiency can also be adjusted by adjusting the cross-section structure of the electrodes. In this way, drive signals from the drive signal system (11) are input into the second modulated electrode (16) and the modulated signals output from the second modulated electrode (16) are input into the first modulate electrode (15), thereby improving power efficiency by around 3 dB.

[Description of Each Component]

Hereinafter each component of an optical frequency comb generator of the present invention will be described.

A light source used in an optical frequency comb generator of the present invention includes a light source capable of outputting continuous light (CW) such as a distributed-feedback semiconductor laser (DM laser). An automatic power control DFB laser is preferable as it has high wavelength selectivity. An optical bandwidth may be C-band as well as its long-wavelength L-band or its short-wavelength S-band. An optical intensity may be 1 mW-50 mW, for example.

As a waveguide used in an optical frequency comb generator of the present invention, any known waveguide used in an optical modulator can be used appropriately. A preferred embodiment of an optical modulator of the present invention is a Mach-Zehnder optical modulator. Thus, hereinafter a waveguide will be described focusing on a Mach-Zehnder optical modulator. Typically, a Mach-Zehnder waveguide or an electrode is provided on a substrate. A substrate or each waveguide is not particularly limited as far as they can propagate light. For example, a Ti diffusion lithium-niobate waveguide may be formed on a UN (LiNbO₃) substrate. Alternatively, a silicon dioxide (SiO₂) waveguide may be formed on a silicon (Si) substrate. Otherwise, an optical semiconductor waveguide wherein an InGaAsP or GaAlAs waveguide is formed on an InP or GaAs substrate may be used.

FIG. 3 is a schematic diagram showing a waveguide having an asymmetric cross-section according to the present invention. FIG. 3 shows an example of a Z-cut waveguide. In case a waveguide has such a cross-section, the length of the first modulated electrode and the second modulated electrode may be the same, or the length of these electrodes may be different as shown in FIG. 1 or FIG. 2. FIG. 3 shows an example of a Z-cut LN waveguide, in the upper side of which a hot electrode is provided. And the second waveguide (5) is displaced from the position where modulation efficiency becomes maximum. In FIG. 3, if the distance from the centrally-located ground electrode to the center of the electrode (16) is defined as l, the second waveguide (5) may be displaced from the position where modulation efficiency becomes maximum by between equal to or more than 0.1 l and equal to or less than 1 l, preferably by between equal to or more than 0.2 l and equal to or less than 0.5 l, more preferably by between equal to or more than 0.3 l and equal to or less than 0.4 l. Note, however, that such displacement is not particularly limited as far as it can be adjusted in accordance with the above Formula (I).

FIG. 4 is a schematic diagram showing a waveguide having an asymmetric cross-section according to the present invention. FIG. 4 shows an example of an X-cut waveguide. In this case, the substrate polarization may appropriately be inverted at the position of the centrally-located hot electrode. FIG. 4 shows an example of a waveguide having a hot electrode at the center and ground electrodes across two waveguides. Also in this case, as mentioned above, if the distance from the centrally-located ground electrode to the center of the electrode (16) is defined as l, the second waveguide (5) may be displaced from the position where modulation efficiency becomes maximum by between equal to or more than 0.1 l and equal to or less than 1 l, preferably by between equal to or more than 0.2 l and equal to or less than 0.5 l, more preferably by between equal to or more than 0.3 l and equal to or less than 0.4 l. Note, however, that such displacement is not particularly limited as far as it can be adjusted in accordance with the following Formula (I). As the use of a domain inverted (crystal-axis inverted structure) ferroelectric crystal (LN crystal) can apply in-phase and the same coded modulation to each waveguide, phase shift can be added to the ends of electrodes from one electrode, thereby generating a comb at one electrode only.

A substrate is preferably lithium niobate (LiNbO₃:LN) cut Out to be the X-cut and Z-axis propagation. This is because such a substrate enables low-power driving through the use of a larger electro-optic effect and provides better response speed. An optical waveguide is formed on the surface of the X-cut plane (YZ-plane) of the substrate, and the guided light is propagated along the Z-axis (optic axis). Alternatively, a non-X-cut lithium niobate substrate may be used. Furthermore, as a substrate, an uniaxial crystal such as a trigonal crystal or a hexagonal crystal having an electro-optic effect, or a crystal material whose point group is C₃ᵥ, C₃, D₃, C₃ₕ or D₃ₕ can be used. These materials have the refractive index adjusting function to change the refractive index to opposite code according to the mode of propagation light by applied electric field. As concrete examples, lithium tantalite (LiTO₃:LT), β-BaB₂O₄ (or BBO), LiIO₃, etc. can be used in addition to lithium niobate.

A modulated electrode is preferably connected with a high frequency electrical signal source. The high frequency electrical signal source is a device for generating a signal transmitted to a modulated electrode, and any known high frequency electrical signal source can be used. A frequency (fₘ) of a high frequency signal input into the modulated electrode includes a range of 1 GHz-100 GHz, for example. Output of a high frequency electric signal source includes sinusoidal wave having a constant frequency. A phase modulator is preferably provided at the high frequency electric signal source so as to control the phase of an output signal. In some cases, the electric signals output from the high frequency electric signal source are branched, and one side of branched electric signals is applied to the modulated electrode with the phase etc. adjusted by the modulator (delay device) etc.

A modulated electrode is made up of gold, platinum, etc., for example. The example of the width of a modulated electrode is 1 μm-10 μm, specifically 5 μm. The example of the length of a modulated electrode is 0.1 times to 0.9 times the wavelength of the modulated signal (fₘ), 0.18-0.22 times, or 0.67-0.70 times, more preferably shorter than the resonant point of the modulated signal by 20-25%. This is because with such a length, the synthesized impedance remains in an appropriate region. The example of the more specific length of a modulated electrode is 3250 μm. Hereinafter, a resonant-type electrode and a traveling-wave-type electrode are described.

A resonant-type photoelectrode (resonant-type optical modulator) is an electrode that carries out modulation using resonance of modulated signals. A known resonant-type photoelectrode can be used. One example of such a resonant-type photoelectrode is described in JPA 2002-268025 “Tetsuya Kawanishi, Satoshi Oikawa, Masayuki Oikawa, “Planar structure resonant-type optical modulator”, TECHNICAL REPORT OF IEICE, IQE2001-3 (2001-05)”.

A traveling-wave-type photoelectrode (traveling-wave-type optical modulator) is an electrode (modulator) that guides an optical wave and an electric signal and, during guiding, modulates light (e.g. Hiroshi Nishihara, Masamitsu Haruna, and Toshiaki Suhara, “Optical integrated circuits” (revised and updated edition), Ohmusha, pp. 119-120). A known traveling-wave-type photoelectrode can be used. Examples of such a photoelectrode are disclosed in JPA H11-295674, JPA 2002-169133, JPA 2002-40381, JPA 2000-267056, JPA 2000-471159, JPA H10-133159, etc.

A preferable traveling-wave-type electrode includes one that adopts a so-called symmetric grounding electrode configuration (at least a pair of grounding electrodes is provided on each side of a traveling-wave-type signal electrode). In this way, by arranging grounding electrodes symmetrically across a signal electrode, the high frequency output from the signal electrode is easily applied to the grounding electrodes arranged on either side of the signal electrode. Thus radiation of high frequency to a substrate can be suppressed.

In the present invention, if the (phase) modulation efficiencies per unit length of the first modulating electrode (15) provided along the first waveguide (4) and the second modulating electrode (16) provided along the second waveguide (5) are defined as κ₁ and κ₂, respectively, κ₁ and κ₂ are different.

Ideally, κ₁ and κ₂ may meet the following formula.

$$\frac{L \vert {K}_{1} - {K}_{2} \vert}{2} \pm \frac{ɛ \vert {Vbias}_{1} - {Vbias}_{2} \vert}{2} = \frac{π}{2} \qquad [ Math 1 ]$$

κ₁ and κ₂ [rad/m] indicate the (phase) modulation efficiency per unit length of each arm of the modulator, ε[rad/V] indicates the modulation efficiency per unit voltage for bias voltage, and L indicates the electrode length.

κ₁ and κ₂ are not particularly limited as far as they can be adjusted in accordance with the above Math 1. A specific ratio of κ₁ to κ₂ is, for example, 1.01≦κ1/κ2≦3, preferably 1.1≦κ1/κ2≦2, more preferably 1.2≦κ1/κ2≦1.5. This driving with the electrodes asymmetrically arranged can meet the spectral flattening condition.

The present invention comprises a bias signal system for obtaining a first bias signal (12) for applying to the first waveguide and a second bias signal (13) for applying to the second waveguide. The bias signal system is a signal system for controlling bias voltage applied to two arms. Specifically, the bias signal system comprises a bias power system and a bias adjusting electrode. The bias adjusting electrode is an electrode connected to the bias power system for controlling optical phase propagating between two arms by controlling bias voltage between two arms. Preferably, DC signals or low frequency signals are applied to the bias adjusting electrode. The term “low frequency” in low frequency signals as used herein means the frequency range of 0 Hz-500 MHz, for example. A phase modulator that adjusts the phase of electric signals is preferably provided at the output of the signal source of the low frequency signals in order to control the phase of output signals.

The modulated electrode and the bias adjusting electrode may be configured separately. Alternatively one electrode may double as them. Namely, the modulated electrode may be connected to a feed circuit (bias circuit) for feeding combined DC signals and RF signals.

The optical frequency comb generator preferably comprises a controller connected with signal sources for each electrode electrically (or by optical signal) so as to appropriately control the timing of signals applied to each electrode or the phase. Such a controller functions so as to adjust the modulation timing of the signals applied to the modulated electrode and the bias adjusting electrode. Namely, it adjusts the modulation timing so that the modulation by each electrode is carried out for some specific signals. The adjusting time may be an appropriate value according to the distance among each electrode etc.

[Method for Producing an Optical Frequency Comb Generator]

An optical frequency comb generator of the present invention comprises a substrate, a waveguide provided on the substrate, an electrode, a signal source, etc. As a waveguide formation method, any known method can be used, such as an internal diffusion method such as a titanium diffusion method or a proton exchange method. Namely, the optical frequency comb generator of the present invention can be produced as follows, for example. First, an optical waveguide is formed by patterning titanium on the surface of a wafer of lithium niobate by photolithography and spreading titanium by thermal diffusion method. This is subject to the following conditions: the thickness of titanium is 100-2000 angstrom; diffusion temperature is 500-2000 degrees C.; and diffusion time is 10-40 hours. An insulating buffer layer of silicon dioxide (thickness of 0.5-2 μm) is formed on a principle surface of the substrate. Next, an electrode with metal plating with thickness of 15-30 μm is formed thereon. Subsequently, the wafer is cut off. In this way, an optical modulator whereon a titanium-diffused waveguide is formed is produced.

Furthermore, an optical frequency comb generator can also be produced as mentioned below, for example. First, a waveguide is formed on the substrate. A waveguide can be provided on the substrate surface of lithium niobate by a proton exchange method or a titanium thermal diffusion method. For example, Ti metal stripe (length of few μm) is formed in a row on an LN substrate by photolithographic technique. Subsequently, Ti metal is diffused into the substrate by exposing the LN substrate to high temperature around 1000 degrees C. In this way, a waveguide can be formed on an LN substrate.

Also, an electrode can be produced in the same way as mentioned above. For example, in the same way as a formation of an optical waveguide, by using photolithographic technique, an electrode can be formed on both sides of a plurality of waveguides which are formed in the same breadth, the electrode being formed so that the gap between neighboring electrodes is about 1 μm-50 μm.

In case of producing an electrode using a silicon substrate, the production process, for example, is as follows. A lower cladding layer is disposed on a silicon (Si) substrate by a flame hydrolysis deposition method, the lower cladding layer being made up mostly of silicon dioxide (SiO₂). And then, a core layer is disposed, the core layer being made up mostly of silicon dioxide (SiO₂) to which germanium dioxide (GeO₂) is added as a dopant. Subsequently, vitrification is performed in an electric furnace. And then, an optical waveguide is formed by etching, and an upper cladding layer is disposed, the upper cladding layer being made up mostly of silicon dioxide (SiO₂). And then, a thin-film heater thermo-optic intensity modulator and a thin-film heater thermo-optic phase modulator are formed on the upper cladding layer.

[Condition for Spectral Flattening]

FIG. 1 shows that an optical frequency comb generator provides an optical frequency comb with a flattened optical spectrum. FIG. 5 is a diagram for explaining the concept of the optical frequency comb generation by an optical frequency comb generator of the present invention. Suppose that the RF signals that drives each arm of a Mach-Zehnder modulator are RF-a and RF-b, respectively. The amplitudes of RF-a and RF-b are supposed to be Aₐ (which corresponds to A₁), and A_{b} (which corresponds to A₂), respectively. Furthermore, the modulation frequency is supposed to be ω. Then, RF-a and RF-b can be expressed as the following Formula (1):

RF-a=Aₐ sin ωt, RF-b=A_{b} sin ωt (1)

On the other hand, if the amplitude of light input into a Mach-Zehnder modulator is Eᵢₙ, the electric field Eₒᵤₜ by the output light of the Mach-Zehnder modulator can be represented by the following Formula (2). In Formula (2), Jₖ (x) represents the kth-order Bessel function.

$$\begin{matrix}[ Math 2 ] & \\ {E}_{out} = \frac{1}{2} {E}_{in} {\sum }_{k = - ∞}^{∞} [ {J}_{k} ( {A}_{1} ) {e}^{j kwt + {θ}_{1}} + {J}_{x} ( {A}_{2} ) {e}^{j kwt - {θ}_{2}} ] & ( 2 )\end{matrix}$$

Next, conversion efficiency ηₖ is defined as relative ratio of Pₖ to Pᵢₙ wherein Pₖ represents the intensity of the kth-order frequency comb component and Pᵢₙ represents the intensity of the input light. When the driving signals are large amplitude signals, namely when Aᵢ(t) (i=a or b) is large enough, conversion efficiency ηₖ can be asymptotically approximated as shown in the following Formula (3):

$$\begin{matrix}[ Math 3 ] & \\ η ≡ \frac{{P}_{k}}{{P}_{in}} = \frac{1}{2 π \overline{A}} [ \begin{matrix}1 + cos ( 2 Δθ ) cos ( 2 ΔA ) + \\ \{ cos ( 2 Δ θ ) + cos ( 2 ΔA ) \} cos \{ 2 \overline{A} - \frac{2 k π + 1}{2} \}\end{matrix} ] & ( 3 )\end{matrix}$$

where /A(A bar), ΔA, and Δθ are defined, respectively, as the following Formula (4):

/A≡(A₁+A₂)/2, ΔA≡(A₁−A₂)/2, Δθ≡(θ₁−θ₂)/2 (4)

The condition for obtaining flat spectral properties is the time when ηₖ is not dependent on k, namely the time when Formula (3) is independent from the modulation order k. Thus the condition for obtaining flat spectral properties is guided by the following Formula (5):

ΔA±Δθ=π/2 (5)

Therefore, in order to obtain an optical frequency comb having flat spectral properties, a Mach-Zehnder modulator may be driven so as to meet Formula (5). In Formula (5), ±may be any of plus or minus.

[Conversion Efficiency Maximization]

Next, under this spectral flattening condition, a maximization condition of conversion efficiency is sought. When Formula (5) is substituted into Formula (3), conversion efficiency ηₖ can be represented by a simple formula as shown in the following Formula (6):

$$\begin{matrix}[ Math 4 ] & \\ {η}_{k} = \frac{1 - cos 4 Δθ}{4 π \overline{A}} & ( 6 )\end{matrix}$$

Therefore, the conversion efficiency can be found to be maximized when the following Formula (7) is met:

ΔA=Δθ=π/4 (7)

And the maximum conversion efficiency η_{k,max} when Formula (7) is met can be represented by the following Formula (8):

$$\begin{matrix}[ Math 5 ] & \\ {η}_{k , max} = \frac{1}{2 π \overline{A}} & ( 8 )\end{matrix}$$

As explained above, the condition for obtaining a flattened optical frequency comb by a Mach-Zehnder modulator can be Formula (5) (ΔA±Δθ=π/2). On the other hand, the condition for generating efficiency of the optical frequency comb signal generator being maximum while the above condition of spectral flatness being met is Formula (7) (ΔA=Δθ=π/4), which is the maximum flattening condition. Formula (7) means that a Mach-Zehnder is biased at 2/π point and the maximum phase difference of phase shift induced by driving sine wave signal, RF-a and RF-b, is π.

[Explanation of Operation]

The basic operation of an optical frequency comb generator of the present invention is shown in FIG. 5. Namely, the generator applies driving signals RF-a and RF-b as well as phases-reversed bias signals −Δθ and Δθ to two arms of a Mach-Zehnder modulator. When the central wavelength of the input optical signal is λ₀, then the output optical frequency comb signal has a plurality of frequency components deviated by frequencies (namely wavelengths) according to the frequencies of the driving signal from λ₀.

As an optical comb can generate an optical pulse signal according to the bandwidth, an optical frequency comb generator can also be referred to as an ultrahigh-precision multifrequency optical pulse generator. Namely, though the way to generate an optical pulse using an optical comb generator is known, the above optical pulse generator which uses an optical comb generator of the present invention can enjoy the effects as described above. An optical pulse generator of the present invention can appropriately adopt each component or each step of the optical frequency comb generator and the optical frequency comb generation method as described above.

Furthermore, as respective frequency components generated by an optical comb generator are in synchronization with each other and the phase components are constant, an ultrashort pulse train as well as arbitrary wavelengths can be formed by adjusting the amplitudes and phases of respective frequency components.

FIG. 6 is a schematic diagram of an optical pulse generator which is a preferred embodiment of an optical frequency comb generator of the present invention. As shown in FIG. 6, the optical pulse generator (21) comprises: an optical frequency comb generator (1) as described in any of above; a bandpass filter (22) into which output from the optical frequency comb generator is input, and a distributed fiber (23) into which output from the bandpass filter is input. Each frequency component obtained from the optical comb generator, as the output optical frequency comb is in ultraflat mode, can be represented as in the following formula:

$${A}_{k} = \frac{{E}_{0} sin ( 2 Δ θ )}{\sqrt{2 π \overline{A}}} , {Φ}_{k} = \pm \frac{4 {k}^{2} - 1}{8 \overline{A}} \qquad [ Math 6 ]$$

In the above formula, Aₖ indicates the amplitude of an output signal, and Φₖ (hereinafter also referred to as Φ) indicates the phase of an output signal. k indicates the order of the frequency component of an output signal.

Namely, as an ultraflat comb signal is generated, the amplitude is constant regardless of the frequency order k, and the phase Φ becomes a quadratic function of the frequency order k. And, by providing phase shift −Φ (with a reverse sign) with output of the optical comb generator, the phase difference can be set to 0. In that case, time waveform becomes an impulse function, and thus short optical pulse can be synthesized. Also, as it is known that the phase shift provided by a typical single-mode fiber having wavelength dispersion is a quadratic function of the optical frequency order, the use of a fiber of appropriate length can easily provide −Φ. The fiber length at that time is ideally represented by the following formula, and thus it may be set to a length L appropriately adjusted based on the ideal formula:

$$L = ∓ \frac{{\partial }^{2} {Φ}_{k}}{\partial {k}^{2}} {( {β}_{2} {ω}_{0}^{2} )}^{- 1} ∓ {( {β}_{2} \overline{A} {ω}_{0}^{2} )}^{- 1} \qquad [ Math 7 ]$$

In the above formula, β₂ indicates the group velocity in a fiber.

Namely, an ultrashort pulsed laser such as a picosecond pulsed laser or a femtosecond pulsed laser can easily be obtained only by connecting a bandpass filter and an optical fiber to the above optical frequency comb generator.

A 2.2-ps-width pulse train could be obtained through the use of an optical frequency comb generator having MZM waveguides, a laser diode (1550 nm, p=5.8 db) as a light source of the optical comb frequency generator, and a frequency of 10 GHz as a modulated signal frequency of the optical comb frequency generator. Furthermore, a bandpass filter with a bandwidth of 1 nm and a single-mode fiber of 1100 m length were used. As a result, an ultrashort pulse as shown in FIG. 7 could be obtained.

### INDUSTRIAL APPLICABILITY

The optical frequency comb generator of the present invention is expected to be applied to a multiwavelength light source in WDM transmission system or a short pulsed light source for ultrafast optical transmission/optical measurement, etc. Furthermore, the generator is also expected to be applied as a frequency reference for absolute frequency measurement, remote supply of local signals in microwave/millimeter-wave frequency bands, or a control signal for an allay antenna used in an astronomical observation system such as wireless telescope, etc.

### BRIEF DESCRIPTION OF THE DRAWINGS

FIG. 1 is a schematic diagram of an optical frequency comb generator of the present invention.

FIG. 2 is a schematic diagram showing a preferred configuration of an optical frequency comb generator of the present invention.

FIG. 3 is a schematic diagram showing a waveguide having an asymmetric cross-section according to the present invention.

FIG. 4 is a schematic diagram showing a waveguide having an asymmetric cross-section according to the present invention.

FIG. 5 is a diagram for explaining the concept of how an optical frequency comb of an optical frequency comb generator of the present invention is generated.

FIG. 6 is a schematic diagram of an optical pulse generator which is a preferred embodiment of an optical frequency comb generator of the present invention.

FIG. 7 is a graph of the obtained picosecond pulse as a substitute for a drawing.

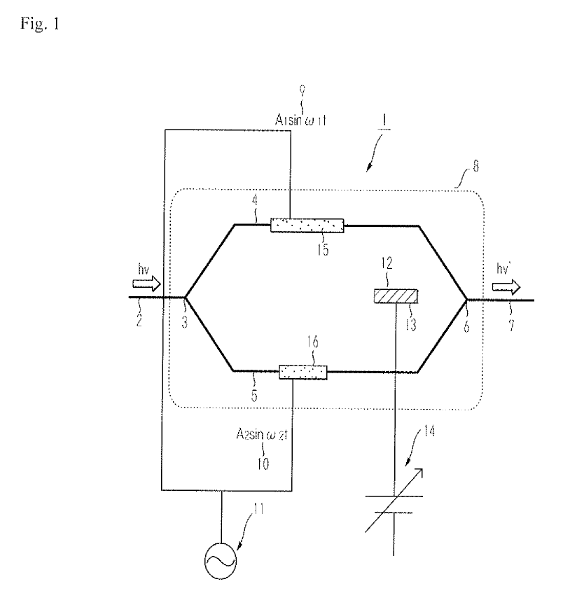

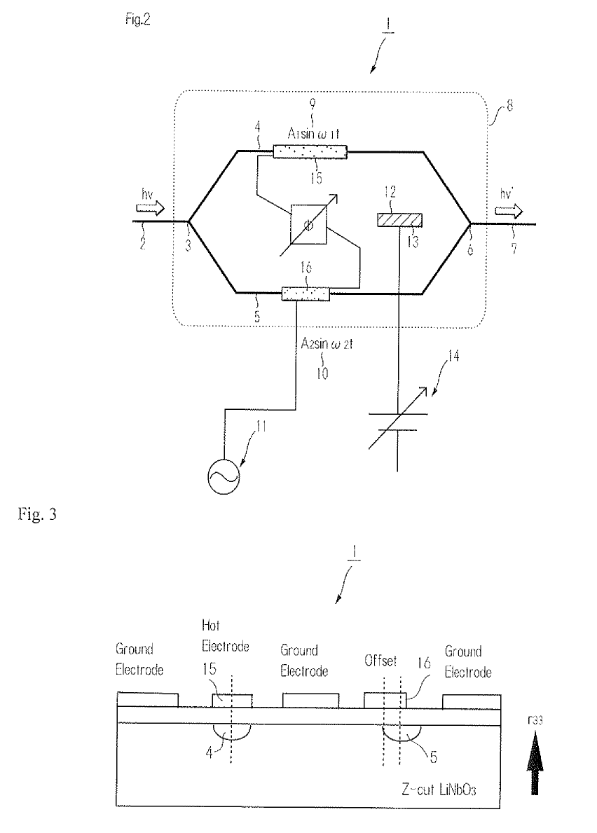

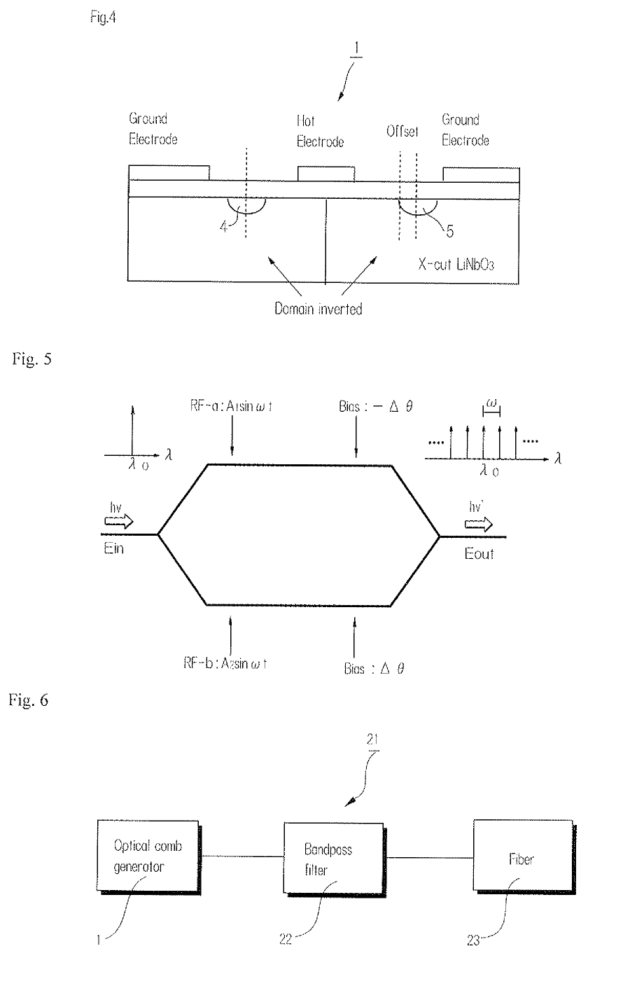

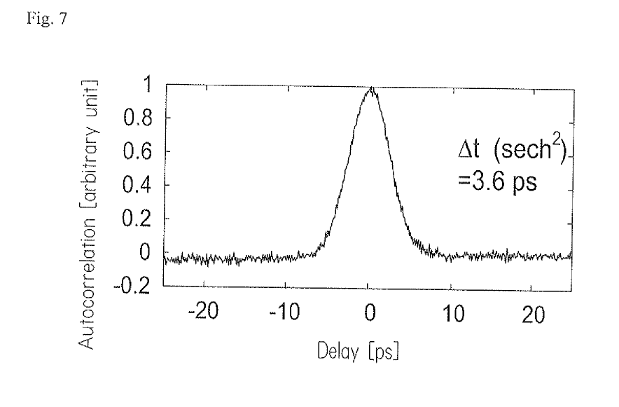

### DESCRIPTION OF THE NUMERALS

1 Optical frequency comb generator
2 Input part
3 Branching part
4 First waveguide
5 Second waveguide
6 Multiplexing part
7 Output part
8 Waveguide part
9 First drive signal
10 Second drive signal
11 Drive signal system
12 Bias signal
13 Bias signal
14 Bias signal system
15 First modulated electrode
16 Second modulated electrode
21 Optical pulse generator
22 Bandpass filter
23 Distributed fiber

1. An optical frequency comb generator (1) comprising:
a waveguide part (8) comprising an optical input part (2), a branching part (3) for branching light from the optical input part, a first waveguide (4) through which light branched by the branching part (3) propagates, a second waveguide (5) through which other light branched by the branching part (3) propagates, a multiplexing part (6) for multiplexing optical signals output from the first waveguide and the second waveguide, and an optical signal output part (7) for outputting optical signals multiplexed by the multiplexing part;
a drive signal system (II) for obtaining a first drive signal (9) for driving the first waveguide (4) and a second drive signal (10) for driving the second waveguide (5); and
a bias signal system (14) for obtaining bias signals (12,13) applied to the first waveguide (4) and the second waveguide (5),
wherein the first drive signal (9) and the second drive signal (10) are obtained from one drive signal system (11),
wherein the length l₁ of a first modulated electrode (15) provided along the first waveguide (4) and the length l₂ of a second modulated electrode (16) provided along the second waveguide (5) are different from each other,
and wherein the drive signal system (11) and the bias signal system (14) drive the first drive signal (9), the second drive signal (10) and the bias signals (12,13) in accordance with the following Formula (I):
ΔA±Δθ=π/2 (I)
(where ΔA and Δθ are defined, respectively, as ΔA≡(A₁−A₂)/2 and Δθ≡(θ₁−θ₂)/2, and A₁ and A₂ indicate, respectively, optical phase shift amplitudes induced by the first drive signal and the second drive signal when input into the electrodes, and θ₁ and θ₂ indicate, respectively, optical phase shift amounts induced within the first waveguide and the second waveguide.)

2. The optical frequency comb generator as claimed in claim 1,
wherein the Formula (I) is the following Formula (II):
ΔA=Δθ=π/4 (II)
(where ΔA and Δθ are defined synonymously above)

3. The optical frequency comb generator as claimed in claim 1,
wherein the waveguide part (8) is a Mach-Zehnder waveguide.

4. The optical frequency comb generator as claimed in claim 1,
wherein the first modulated electrode (15) and the second modulated electrode (16) are electrically connected,
and wherein the drive signal system (11) drives modulated signals so that drive signals are input into the second modulated electrode (16) and the modulated signals output from the second modulated electrode (16) are input into the first modulated electrode (15), and the modulated signals applied to the second modulated electrode (16) and the modulated signals applied to the first modulated electrode are in-phase.

5. The optical frequency comb generator as claimed in claim 1,
wherein the waveguide part (8) is provided on a domain inverted ferroelectric crystal substrate.

6. An optical pulse generator comprising: an optical frequency comb generator as described in claim 1, a bandpass filter into which output from the optical frequency comb generator is input, and a distributed fiber into which output from the bandpass filter is input.

7. An optical frequency comb generator comprising:
a waveguide part (8) comprising an optical input part (2), a branching part (3) for branching light from the optical input part, a first waveguide (4) through which light branched by the branching part (3) propagates, a second waveguide (5) through which other light branched by the branching part (3) propagates, a multiplexing part (6) for multiplexing optical signals output from the first waveguide and the second waveguide, and an optical signal output part (7) for outputting optical signals multiplexed by the multiplexing part;
a drive signal system (11) for obtaining a first drive signal (9) for driving the first waveguide (4) and a second drive signal (10) for driving the second waveguide (5); and
a bias signal system (14) for obtaining bias signals (12,13) applied to the first waveguide (4) and the second waveguide (5),
wherein the first drive signal (9) and the second drive signal (10) are obtained from one drive signal system (11),
wherein either or both of the first waveguide and second waveguide are displaced from the condition where modulation efficiency becomes maximum in accordance with the following Formula (I),
and wherein the drive signal system (11) and the bias signal system (14) drive the first drive signal (9), the second drive signal (10) and the bias signals (12,13) in accordance with the following Formula (I):
ΔA±Δθ=π/2 (I)
(where ΔA and Δθ are defined, respectively, as ΔA≡(A₁−A₂)/2 and Δθ≡(θ₁−θ₂)/2, and A₁ and A₂ indicate, respectively, optical phase shift amplitudes induced by the first drive signal and the second drive signal when input into the electrodes, and θ₁ and θ₂ indicate, respectively, optical phase shift amounts induced within the first waveguide and the second waveguide.)
